(19) United States
(12) Patent Application Publication
(10) Pub. No.: US 2026/0141884 A1
(43) Pub. Date: May 21, 2026

(54) COMPOSITE ELEMENT WITH SOUND REDUCTION EFFECT

(71) Applicant: Walter Stranak, Lauda-Königshofen (DE)

(72) Inventor: Walter Stranak, Lauda-Königshofen (DE)

(21) Appl. No.: 19/311,096

(22) Filed: Aug. 27, 2025

(30) Foreign Application Priority Data
Aug. 29, 2024 (DE) 10 2024 124 641.3

(51) Int. Cl. G10K 11/168; B32B 21/02; B32B 21/08; B32B 21/14

(52) U.S. Cl. CPC G10K 11/168; B32B 21/02; B32B 21/08; B32B 21/14; B32B 2250/04; B32B 2250/05; B32B 2255/08; B32B 2255/26; B32B 2264/06; B32B 2307/102; B32B 2307/718; B32B 2471/00; B32B 2479/00

(57) ABSTRACT

A composite element with sound reduction effect is provided. The composite element comprises: a carrier plate, a lacquer layer joined to the carrier plate, which contains cork powder, and a covering layer which is joined to a side of the lacquer layer facing away from the carrier plate.

### CROSS-REFERENCE TO RELATED APPLICATIONS

This patent application claims priority to German utility patent application number 10 2024 124 641.3 filed Aug. 29, 2024, and titled “composite element with sound reduction effect”. The subject matter of patent application number 10 2024 124 641.3 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to a composite element with sound reduction effect, as well as a floor element and a piece of furniture with or made from such a composite element.

### BACKGROUND

EP 4 382 577 A1 discloses a coating for a floor element, which has a coating lacquer for application to the floor element, wherein the coating lacquer comprises cork powder. The coating lacquer is applied to the side of the floor element opposite the visible side.

### SUMMARY

The object of the present invention is to provide a composite element with improved sound reduction, in particular a floor element and a piece of furniture equipped with such a composite element.

This object is attained in each case by the features of the independent claims. Advantageous embodiments are the subject-matter of the dependent claims.

According to claim 1, a composite element with a sound reduction effect is provided. The composite element comprises: a carrier plate, a lacquer layer joined to the carrier plate and containing cork powder, and a covering layer joined to a side of the lacquer layer facing away from the carrier plate.

When using flooring or furniture, unwanted sound may occur, which can lead to disturbing noises both within the room and in adjacent rooms. The lacquer layer in combination with the cork powder reduces the sound generated when the composite element is used. In particular, the sound is transmitted from the covering layer to the lacquer layer and is dampened by the cork powder contained in the lacquer layer.

For example, the composite element can be a floor element, whereby the lacquer layer containing the cork powder reduces both footfall sound and impact sound. This reduces disturbance caused by sound both for people in the room and for people in adjacent rooms to which the sound may propagate via the floor, ceiling, or walls. Footfall sound is the sound produced in response to walking on a floor that can be perceived in the same room. Impact sound is the sound that is transmitted to other rooms via the floor substructure (only through structure-borne sound transmission) when walking on the floor and can be perceived there.

By using the composite element, it is not necessary to provide an additional separate layer for sound insulation when laying a floor below the floor covering. This eliminates an additional step when laying the floor, which reduces the time required for installation.

Alternatively, the composite element can also be part of a piece of furniture. An example of this is a table. When the table is in use, i.e., when working on its surface, sound can be generated that leads to unwanted disturbances in the room. This generated sound is reduced by the lacquer layer containing the cork powder. Thus, noises caused by the use of the table, for example, by pens rattling on the table surface or the like, can be reduced. In particular, this reduces disturbances in classrooms, making lessons more pleasant and efficient for both students and teachers.

### BRIEF DESCRIPTION OF THE DRAWINGS

In the following, the invention is further explained below with reference to the examples shown in the accompanying drawings:

FIG. 1 shows a lateral cross-sectional view of a composite element, in particular a flat floor element;

FIG. 2 shows a lateral cross-sectional view of a further composite element; and

FIG. 3 shows a lateral cross-sectional view of a table with a composite plate.

### DETAILED DESCRIPTION

The lacquer coating with cork powder is preferably characterized by the fact that it is easy to process, especially by machine.

A ‘composite element’ is understood here to mean an element with several layers, in particular at least three layers (carrier plate, lacquer layer, covering layer).

The individual layers of the composite element are preferably joined by bonding and/or heat fusing and/or pressing. For example, a primer is first applied to the carrier plate to improve the adhesion of the lacquer layer to be applied subsequently. The covering layer is preferably joined to the lacquer layer by melt pressing. The lacquer layer preferably has a viscosity that is suitable for processing the lacquer layer by machine, for example by means of an application roller.

The lacquer layer preferably has a thickness of at most 1.5 mm, 1.2 mm, 0.9 mm, 0.6 mm, or 0.3 mm, and particularly preferably a thickness of 0.2 mm or essentially 0.2 mm. The lacquer layer preferably has a minimum thickness of 0.05 mm, 0.07 mm, or 0.1 mm. Such layer thicknesses can advantageously be applied in a single step, which facilitates the manufacturing process of the composite element.

The lacquer layer preferably has a weight per unit area in the range of 60 -160 g/m², 70-140 g/m², 80-120 g/m² or 90-100 g/m².

The lacquer layer preferably consists of a UV-curable or UV-cured lacquer.

The lacquer layer preferably consists only of natural components, synthetic components, or mixtures thereof. The lacquer layer can be a synthetic resin, alkyd resin, polyurethane or nitrocellulose lacquer or can contain these. Depending on the requirements, a cost-effective or environmentally friendly coating can be produced in order to create application-specific coatings (e.g., suitable for living spaces). The lacquer layer can be made, for example, from water-based lacquers, synthetic lacquers such as polyester, polyurethane, epoxy, acrylates.

Preferably, the above-mentioned lacquer layer forms a first lacquer layer, and the composite element has a second lacquer layer containing cork powder, which is arranged on a side of the carrier plate facing away from the first lacquer layer. The additional second lacquer layer with the cork powder results in improved sound reduction compared to a single lacquer layer with cork powder.

The second lacquer layer is preferably designed like the first lacquer layer. All features of the (first) lacquer layer described herein are also applicable to the second lacquer layer.

The cork powder preferably has a grain size (preferably average grain size) in the range of 0.1 to 1 mm, 0.1 to 0.8 mm, 0.1 to 0.5 mm, or 0.1 to 0.3 mm. This grain size allows easy processing and ensures appropriate sound reduction or sound insulation.

Preferably, the (average) grain size or grain size distribution of the cork powder is smaller than or equal to the thickness of the lacquer layer.

For example, for a lacquer layer having a thickness of 1.5 mm, the cork powder may have an (average) grain size in a range of 0.1 to 1.5 mm, 0.1 to 1 mm, 0.1 to 0.8 mm, 0.1 to 0.5 mm, or 0.1 to 0.3 mm.

For example, for a lacquer layer having a thickness of 1.2 mm, the cork powder may have an (average) grain size in a range of 0.1 to 1.2 mm, 0.1 to 1 mm, 0.1 to 0.8 mm, 0.1 to 0.5 mm, or 0.1 to 0.3 mm.

For example, for a lacquer layer having a thickness of 0.9 mm, the cork powder may have an (average) grain size in a range of 0.1 to 0.9 mm, 0.1 to 0.8 mm, 0.1 to 0.5 mm, or 0.1 to 0.3 mm.

For example, for a layer thickness in the of 0.6 mm, the cork powder may have an (average) grain size in the range of 0.1 to 0.6 mm, 0.1 to 0.5 mm, or 0.1 to 0.3 mm.

For example, for a lacquer layer with a thickness of 0.3 mm, the cork powder may have an (average) particle size in a range of 0.1 to 0.3 mm or 0.1 to 0.2 mm.

For example, for a lacquer layer with a thickness of 0.2 mm, the cork powder may have an (average) particle size in a range of 0.1 to 0.2 mm.

The cork powder may have a grain size distribution of a single or essentially a single grain size (i.e., the cork powder particles have the same or essentially the same grain size) or different grain sizes. The variety of grain sizes employed may be adjusted with regard to the desired processability. In industrial processing, the use of a single grain size produces a good and consistent quality of the composite element and its sound reduction effect. It is preferable for the cork powder to be distributed spatially evenly within the lacquer layer. This ensures uniform sound reduction across the entire composite element.

The proportion of cork powder in the lacquer layer is preferably in the range of 5 to 75 vol %, 5 to 65 vol %, 5 to 60 vol % or 5 to 50 vol %.

Preferably, the lacquer layer is applied to the carrier plate in a single layer. The lacquer layer can be applied to the entire surface of the carrier plate. Preferably, the lacquer layer is applied to the carrier plate in a single pass or step.

This allows for simple and quick production. Alternatively, the lacquer layer can be formed from several individually applied lacquer layers.

Preferably, the covering layer is formed from a decorative layer joined to the lacquer layer and/or a top layer. The top layer is preferably located on the outside of the decorative layer, opposite the lacquer layer. The top layer can be made of melamine resin or a polymer film, for example made of polyvinyl chloride, polyester, polyethylene, polyurethane, polyolefin, or a mixture of these polymers.

The decorative layer forms the visually perceived surface. When the composite element is used as a floor laminate, the decorative layer can be made of paper or a film, for example. Motifs such as wood structures, the appearance of stone, tiles or similar can be printed on the decorative layer. Alternatively, the decorative layer can be printed directly onto the top layer. During manufacture, the top layer is preferably applied to the decorative layer in liquid form, in particular liquid melamine resin.

When the composite element is used as a parquet floor, the decorative layer is preferably made of genuine wood. For example, a thin genuine wood veneer is bonded to the lacquer layer. The genuine wood can have a thickness in the range of 0.3-0.5 mm, 0.5-1.5 mm or 1-3.5 mm. Preferably, a counteracting layer is applied to the underside of the carrier plate, for example also a layer of (inexpensive) genuine wood veneer and/or, for example, in the same layer thickness as the visible genuine wood decorative layer. Preferably, the second lacquer layer (see below) is then applied to the underside of the counteracting layer. A lacquer or oil can be applied to the genuine wood layer, for example. Alternatively, the counteracting layer can be made of paper, plastic, UV lacquer, or UV impact sound lacquer.

The carrier plate is preferably made of pressure-resistant wood-based material and is designed in particular as a medium-density (MDF) or high-density and/or high-compression (HDF) fiberboard. Alternatively, the carrier plate can be made of a plastic such as vinyl.

The carrier plate can have a layer thickness in the range of 2 to 4 mm, 3 to 5 mm, 4 to 6 mm, or 5 to 8 mm.

If the sound reduction element is designed as a floor element, the carrier plate may have a profile for a precise joining of the floor elements, for example, protruding edges or edges for a tongue and groove connection. This results in easy installation and a stable connection between the floor elements. The profiles may be provided on the frontal side and/or longitudinal side of the floor element.

Furthermore, the floor element can have a counteracting layer which is arranged on a side of the carrier plate facing away from the lacquer layer. The counteracting layer can be made of paper, plastic, UV lacquer or UV impact sound lacquer, for example. The counteracting layer prevents the floor element from deforming under load due to the bending forces that occur. If the second lacquer layer is present, it is preferably arranged on a side of the counteracting layer facing away from the carrier plate.

Furthermore, a floor element with or formed from a composite element as described herein is provided, wherein the covering layer of the composite element forms the visible side or upper side of the floor element. The composite element is preferably designed in the form of the floor element. The shape and size can be varied or adapted depending on the application. In this case, the carrier plate of the composite element forms the carrier plate of the floor element, and the covering layer of the composite element forms the top layer and/or decorative layer of the floor element.

Furthermore, a piece of furniture with or formed from a composite element as described herein is provided, wherein the composite element is arranged such that the covering layer of the composite element faces outward. Preferably, the covering layer is the visible outer side of the (closed) piece of furniture. Preferably, the composite element and, in particular, the lacquer layer extends over the entire or substantially entire outer surface of the piece of furniture.

For example, the piece of furniture is a table, wherein, in particular, the tabletop is formed from the composite element and the covering layer faces upward or forms the table surface.

Individual features disclosed in this description above or below or in the claims may be claimed in any combination or sub combination with each other. Features of the composite element, the floor element, and the piece of furniture may be combined with each other as individual features or in any sub combination of features. Where the conjunction “and/or” is used here, all logical elements and combinations are disclosed individually; for example, a, b, and/or c disclose the elements/combinations a, b, c, ab, ac, bc, and abc.

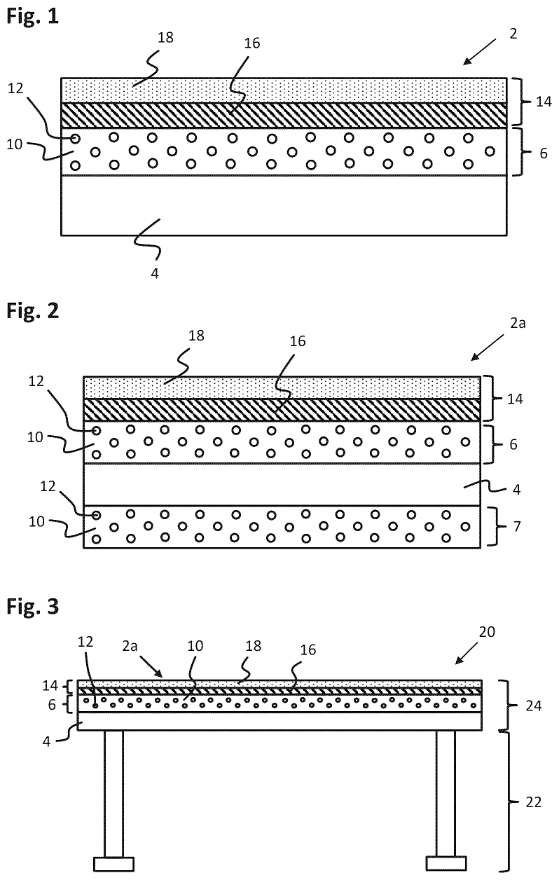

FIG. 1 shows a lateral cross-sectional view of a composite element 2 with sound reduction effect. The composite element 2 can be designed as a floor element, for example. The composite element 2 comprises: a carrier plate 4, a lacquer layer 6 joined to the carrier plate 4, which contains cork powder 12, and a covering layer 14, which is joined to a side of the lacquer layer 6 facing away from the carrier plate 4. The size and shape of the composite element 2 can be varied or adapted depending on the application. The lacquer layer 6 serves for sound insulation and, in particular when implemented as a floor element, for reducing footfall sound and impact sound.

The carrier plate 4 is preferably made of a pressure-resistant wood-based material and in particular as a medium-density (MDF) or high-density and/or high-compression (HDF) fiberboard. Alternatively, the carrier plate 4 can be made of a plastic such as vinyl.

The lacquer layer 6 preferably consists only of natural components but may also consist of mixtures thereof. For example, the lacquer layer 6 is a synthetic resin, alkyd resin, polyurethane, or nitrocellulose lacquer.

The lacquer layer 6, for example, may have a thickness of 0.2 mm or essentially 0.2 mm and/or a weight per unit area in the range of 90-100 g/m². Preferably, the lacquer layer 6 comprises a UV-curable or UV-cured lacquer 10.

The lacquer layer 6 comprises the cork powder 12 or the cork powder 12 is incorporated (i.e., dispersed) in the lacquer layer. Preferably, the cork powder 12 is evenly distributed in the lacquer 10 of the lacquer layer 6 and, in particular, has only a single grain size or a grain size distribution which has a bell-shaped distribution (e.g., Gaussian distribution) around the mean value. The grain size of the cork powder 12 (i.e., the grain size of the cork powder particles) is preferably in the range of 0.1 to 0.3 mm. Advantageously, the cork powder 12 has a grain size distribution of a single grain size, but predetermined varieties of different grain sizes can also be used. The proportion of cork powder in the lacquer layer 6, for example, can be in the range of 5 to 50 vol %.

The covering layer 14 can be formed from a decorative layer 16 joined to the lacquer layer 6 and/or a top layer 18. Preferably, the covering layer 14 has the decorative layer 16 and the top layer 18, wherein the top layer 18 is preferably arranged on the outside of the decorative layer 16 on a side opposite the lacquer layer 6.

The top layer 18, for example, can be formed from melamine resin or a polymer film, for example made of polyvinyl chloride, polyester, polyethylene, polyurethane, polyolefin, or a mixture of these polymers.

FIG. 2 is a lateral cross-sectional view of a further composite element 2a. The composite element 2a differs from the composite element 2 in FIG. 1 in that the composite element 2a, in addition to the first lacquer layer 6 (see FIG. 1), has a second lacquer layer 7 which contains cork powder 12 and is arranged on a side of the carrier plate 4 facing away from the first lacquer layer 6. In a floor covering, the second lacquer layer, for example, is arranged on the underside of the carrier plate 4. The second lacquer layer 7 is designed preferably identical to the first lacquer layer 6. All other features described here in relation to composite element 2 in FIG. 1 (and 3) also apply to composite element 2a in FIG. 2.

FIGS. 1 and 2 describe the exemplary application of composite elements 2, 2a as floor elements.

As shown in FIG. 3, composite element 2 (or composite element 2a) can alternatively be used in a piece of furniture such as a table 20. The table 20 has a table frame 22 and a tabletop 24 arranged on the table frame 22. As shown in FIG. 3, the tabletop 24 may comprise the composite element 2 or be formed from the composite element 2, wherein the covering layer 14 faces upward and forms the upper side of the tabletop 24.

When the table 20 is used, sound generated, for example, by knocking, clattering pens or similar objects on the tabletop 24 is reduced by the composite element 2 and in particular by the lacquer layer 6. This reduces the noise levels in a classroom, for example.

What is claimed is:

1. Composite element with sound reduction effect, comprising:
a carrier plate,
a lacquer layer joined to the carrier plate and containing cork powder, and
a covering layer joined to one side of the lacquer layer facing away from the carrier plate.

2. Coating Composite element according to claim 1, wherein the lacquer layer has a thickness of at most 1.5 mm, 1.2 mm, 0.9 mm, 0.6 mm or 0.3 mm, particularly preferably a thickness of 0.2 mm or essentially 0.2 mm, and/or wherein the lacquer layer has a weight per unit area in the range of 60 -160 g/m², 70-140 g/m², 80-120 g/m² or 90-100 g/m².

3. Composite element according to claim 1, wherein the lacquer layer consists of a UV curable or UV-cured lacquer.

4. Composite element according to claim 1, wherein the lacquer layer (6) consists only of natural components, synthetic components or mixtures thereof, and/or wherein the lacquer layer (6) is or comprises a synthetic resin, alkyd resin, polyurethane or nitrocellulose lacquer.

5. Composite element according to claim 1, wherein the cork powder has a grain size distribution in the range of 0.1 to 1 mm, 0.1 to 0.8 mm, 0.1 to 0.5 mm or 0.1 to 0.3 mm.

6. Composite element according to claim 1, wherein the cork powder has a grain size distribution of a single or essentially a single grain size or of different grain sizes.

7. Composite element according to claim 1, wherein the proportion of cork powder in the lacquer layer is in the range of 5 to 75 vol %, 5 to 65 vol %, 5 to 60 vol % or 5 to 50 vol %.

8. Composite element according to claim 1, wherein the lacquer layer is applied in a single layer.

9. Composite element according to claim 1, wherein the covering layer is formed from a decorative layer and/or a top layer joined to the lacquer layer, and wherein, preferably the top layer is arranged on the outside of the decorative layer opposite the lacquer layer, and/or wherein, preferably the top layer is made of melamine resin or a polymer film, for example made of polyvinyl chloride, polyester, polyethylene, polyurethane, polyolefin or a mixture of these polymers, or wherein, preferably the top layer is a veneer layer, more preferably a genuine wood veneer layer.

10. Composite element according to claim 1, wherein the carrier plate is made of pressure-resistant wood-based material and is in particular designed as medium-density (MDF) or high-density and/or high-compression (HDF) fiberboard, or wherein the carrier plate is made of a plastic such as vinyl.

11. Composite element according to claim 1, wherein the lacquer layer forms a first lacquer layer and the composite element has a second lacquer layer which contains cork powder and is arranged on a side of the carrier plate facing away from the first lacquer layer.

12. Floor element with or formed from a composite element according to claim 1, wherein the covering layer of the composite element forms a visible side of the floor element.

13. Piece of furniture with or made from a composite element according to claim 1, wherein the composite element is arranged such that the covering layer of the composite element faces outward on the piece of furniture.
